(19) United States
(12) Patent Application Publication
(10) Pub. No.: US 2011/0217875 A1
(43) Pub. Date: Sep. 8, 2011

(54) RECEPTACLE POWER MANAGEMENT SYSTEM AND MANAGING METHOD THEREOF

(75) Inventor: YU-LUNG LEE, MIAOLI COUNTY (TW)

(73) Assignee: POWERTECH INDUSTRIAL CO., LTD., TAIPEI HSIEN (TW)

(21) Appl. No.: 12/795,036

(22) Filed: Jun. 7, 2010

(30) Foreign Application Priority Data
Mar. 5, 2010 (TW) 99106485

(51) Int. Cl. H01R 13/66

(52) U.S. Cl. 439/620.24

(57) ABSTRACT

A receptacle device is disclosed. The receptacle device includes a body, a setting unit for setting address information of the receptacle device, a processing unit for generating an address signal according to the address information, and a communication unit for transmitting the address signal to the host so as to manage the distribution of the receptacle device.

### BACKGROUND OF THE INVENTION

1. Field of the Invention

The present invention relates to a receptacle device, a power management system and a power managing method of the power management system. In particular, the present invention relates to the receptacle device that is capable of setting address information of the receptacle device and generating a corresponding address signal.

2. Description of Related Art

The electronic equipments have been becoming an indispensable part of most people's daily lives. With most of the electronic equipments powered through plug receptacles, power usage and consumption associated with the plug receptacles become more and more important. In order to increase the safety of the power usage and minimize the waste of power, a remote control of the delivery of the power to the receptacles connected to the electronic equipments and a real-time access to the condition associated with the receptacles including how much power has been consumed and the temperature may be critical. For example, when the receptacles are still powered even after the electronic equipments have been removed from the receptacles, causing the temperature of the receptacles to remain at relatively high levels, to remotely disconnect the receptacles from the power may help reduce the power consumption. To do so, the receptacle device and the address thereof must be identified.

Since the conventional pairing of the receptacle devices and a host computer monitoring the receptacle devices heavily relies on human operations such as “coding” the receptacle devices before they could be monitored, it may not serve as a viable option when an enormous number of the receptacle devices are present and the receptacle devices are located at many different positions of a building. Meanwhile, the conventional technology offers no solution to monitoring additional receptacle devices as being unable to get the address information regarding the newly-added receptacle device.

### SUMMARY OF THE INVENTION

One objective of the present invention is to set the position information of the receptacle device for remotely controlling and monitoring the electricity status of the receptacle device in a tall and large building.

The receptacle device includes a body, a setting unit for setting address information of the receptacle device, a processing unit for generating an address signal according to the address information, and a communication unit for transmitting the address signal to a host.

The power management system includes a plurality of receptacle devices for receiving an electronic load and generating an address signal relative to the position of the receptacle devices, and a host for receiving the address signal and transmitting a control signal to the receptacle devices. Each one of the receptacle devices includes a body, a setting unit for setting address information of the receptacle device, a processing unit for generating an address signal according to the address information and controlling the receptacle device to deliver power to the electronic load according to the control signal, and a communication unit for transmitting the address signal.

The power managing method of the power management system wherein the power management system comprises a plurality of receptacle devices and a host, and the managing method comprises transmitting a polling signal to the receptacle devices by the host, transmitting an address signal to the host by the receptacle devices wherein the address signal corresponding to an address information of the receptacle device, and controlling the receptacle device to deliver a power to an electronic load by the host.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a schematic diagram of a receptacle device in accordance with one embodiment of the present invention,

FIG. 2 is a schematic diagram of a receptacle device in accordance with another embodiment of the present invention,

FIG. 3 is a schematic diagram of a power management system in accordance with one embodiment of the present invention,

FIG. 4 is a functional block diagram of the receptacle device in accordance with one embodiment of the present invention, and

FIG. 5 is a flowchart illustrating a managing method of the power management system in accordance with one embodiment of the present invention.

### DETAILED DESCRIPTION OF THE PREFERRED EMBODIMENTS

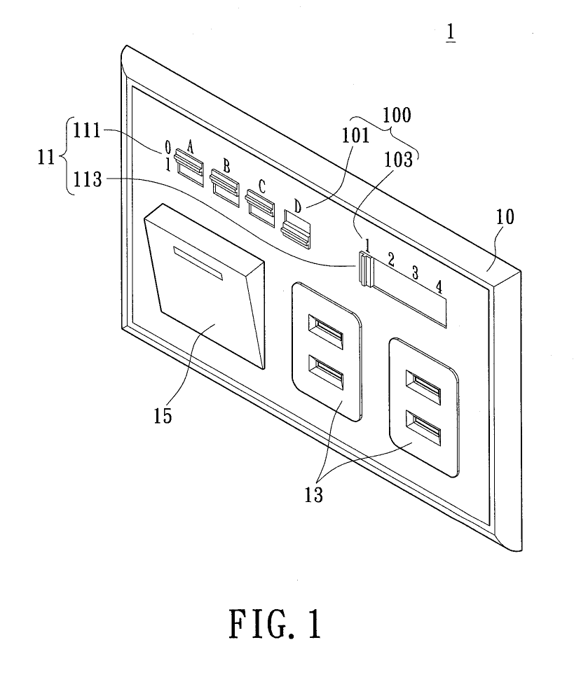

FIG. 1 is a schematic diagram of a receptacle device in accordance with one embodiment of the present invention.

Throughout the disclosure, the receptacle device 1 includes a body 10, a setting unit 11, a plug interface 13 and a switch unit 15 wherein the setting unit 11, the plug interface 13 and the switch unit 15 are mounted on the body 10. In one implementation, the receptacle device 1 could be a wall receptacle device. In another implementation, the receptacle device 1 could be an in-wall receptacle device.

The plug interface 13 may have a plurality of sets of plug holes for receiving electrical plugs such as the plugs of power supply, co-axial cable (Coax), high definition multimedia interface (HDMI), digital visual interface (DVI), primary colors (RGB), video graphics acceleration (VGA) or universal serial bus (USB). The switch unit 15 could be a dip switch, a knob switch or a press portion enabling an on/off switch for an electronic load such as lamp switch or air condition switch.

In one implementation, the setting unit 11 could be a dip switch for setting address information of the receptacle device 1. There could be more than one setting unit 11 for receiving the address information of different levels. For example, the setting unit 11 may include a first setting unit 111 and a second setting unit 113 wherein the first setting unit 111 is configured to set division information, which is a part of the address information, corresponding to the division of the receptacle device 1. In one implementation, the division information of the receptacle device 1 indicates that the receptacle device 1 is at the bed room, the living room or the kitchen. And the second setting unit 113 is configured to set position information, which is a part of the address information as well, corresponding to the position of the receptacle device 1. The position information may be used to indicate that the receptacle device 1 is by the door/window or at the corner of the wall.

The receptacle device 1 may further have a prompt unit 100 mounted on the body 10 for instructing the user to define the address information of the receptacle device 1. The prompt unit 100 could be associated with characters. The prompt unit 100 has a first indicator region 101 and a second indicator region 103 corresponding to the first setting unit 111 and the second setting unit 113, respectively. In one implementation, the first setting unit 111 could be a plurality of two-step dip switches, each of which associates with the characters indicative of to its respective division information in the first indicator region 101. For example, that when one dip switch is flipped to “on” while other dip switches are at “off” may correspond to a predefined division. The second setting unit 113 could be including a plurality of multi-step dip switches, each of which is associated with the characters indicative of its respective position information at the second indicator region 103. And the combinations of the characters may indicate the positions of the receptacle device 1.

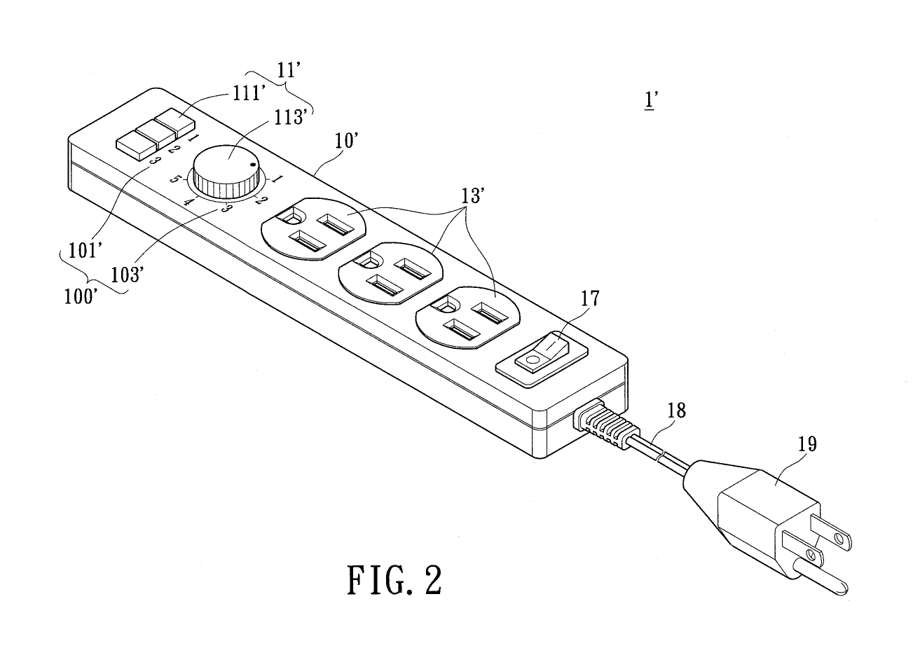

FIG. 2 is a schematic diagram of a receptacle device in accordance with another embodiment of the present invention.

The receptacle device 1′ includes a body 10′, a setting unit 11′, a plug interface 13′ and power supply switch unit 17 wherein the setting unit 11′, plug interface 13′ and power supply switch unit 17 are mounted on the body 10′. The body 10′ includes a prompt unit 100′. The receptacle device 1′ could be a power strip receptacle device.

The receptacle device 1′ is coupled with a plug 19 via a wire 18 so that the receptacle device 1′ could be in connection with a conventional wall receptacle device (not shown), which could be a receptacle device without the setting unit 10 and the prompt unit 100 shown in FIG. 1. It is worth noting that the power supply switch 17 when switched determines whether the receptacle device 1′ receives a power via the wire 18 through the plug 19.

In one implementation, the setting unit 11′ includes a first setting unit 111′ and a second setting unit 113′. The first setting unit 111′ is configured to set the division information of the receptacle device 1′ while the second setting unit 113′ is configured to set the position information of the receptacle device F. The first setting unit 111′ could be a plurality of press portions and the second setting unit 113′ could be a multi-step knob. The prompt unit 100′ has a first indicator region 101′ and a second indicator region 103′. The first indicator region 101′ and the second indicator region 103′ are associated with the characters through which and the combinations thereof the division and position of the receptacle device 1′ may be defined.

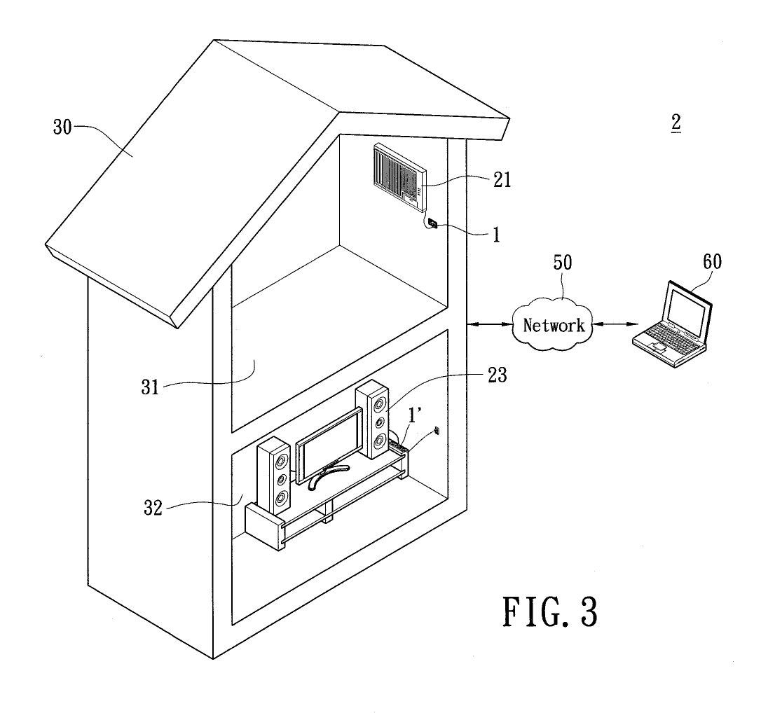

FIG. 3 is a schematic diagram of a power management system in accordance with one embodiment of the present invention.

The power management system 2 includes the receptacle devices 1, and 1′ and a host 60 wherein the receptacle device 1 is placed in first division 31 of a building 30 and is connected with a first electronic load 21, and the receptacle device 1′ is placed in second division 32 and is connected with a second electric load 23. The host 60 could be a mobile phone, a personal digital assistant (PDA), a desktop computer, a laptop computer, a server or a working station for remotely monitoring the receptacle devices 1, and F. The receptacle devices 1, 1′ are able to communicate with the host 60 via a network 50. The receptacle device 1 and 1′ may be equipped with a power line communication module for communicating with the host 60 via an original house wire.

When the receptacle devices 1 and 1′ are initially installed in the building 30, the setting units 11 and 11′ may be configured to indicate where the receptacle devices 1 and 1′ are placed according to their respective division and position. As the characters associated with the prompt units 100 and 100′ correspond to distinct divisions and positions, they may serve as guidance when configuring the setting units 11 and 11′. Further, the receptacle devices 1 and 1′ may have built-in comparison table corresponding to the prompt units 100 and 100′ so that any configuration of the prompt units 100 and 100′ could be converted on basis of the built-in comparison table.

When the receptacle devices 1 and 1′ have been installed, and connected with the commercial power, the receptacle devices 1 and 1′ may convert the division and position information inputted by the setting units 11 and 11′ to address signals according to the comparison table, and transmit the address signals to the host 60 via the network 50. The host 60 could thus confirm the number and the position/division of the receptacle devices 1 and 1′ so that at least the address information including the position information and the division information of the receptacle devices 1 and 1′ could be identified at the host 60.

Further, the host 60 is configured to receive a detection signal from the receptacle devices 1 and 1′ wherein the detection signal could contain the environmental condition around the receptacle devices 1 and 1′ or power status of the electronic loads 21 and 23. The environmental condition includes temperature, concentration of carbon dioxide or humidity and the power status includes current, voltage, or power consumption. The host 60 may be configured to send a control signal to the receptacle devices 1 and 1′ according to the detection signal in order to control the receptacle devices 1, 1′ to deliver the power to the electronic loads 21 and so as to achieve goals of efficient power consumption and usage of electricity of more security. The control signal may be transmitted regularly or irregularly by the host 60 according to the settings or upon the receipt of commands/instructions at the host 60.

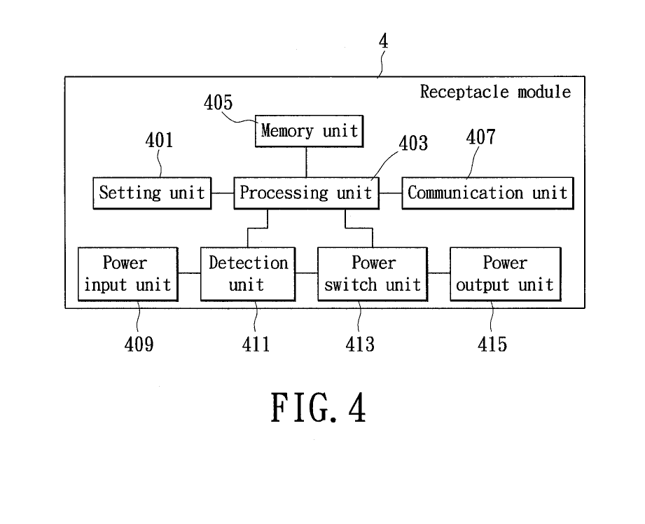

FIG. 4 is a functional block diagram of the receptacle device in accordance with one embodiment of the present invention.

The receptacle device 4 includes a setting unit 401, a processing unit 403, a memory unit 405, a communication unit 407, a power input unit 409, a detection unit 411, a power switch unit 413 and a power output unit 415. The setting unit 401, the memory unit 405, the communication unit 407, the detection unit 411 and the power switch unit 413 are connected with the processing unit 403. The power input unit 409 is connected with the detection unit 411, the power output unit 415 is connected with the power switch unit 413, and the power switch unit 413 is connected with the detection unit 411.

The setting unit 401 is configured to set address information of the receptacle device 4. The memory unit 405 could be a non-volatile memory, a flash memory, or a programmable read-only memory for storing the comparison table and identification (ID) code of the receptacle device 4. For example, the comparison table shown in Table 1 includes characters at the first indicator region and the second indicator region corresponding to different address information. When the setting unit 401 sets the address information by receiving inputs from the prompt unit 100, the processing unit 403 is configured to compare the inputs to the comparison table and convert the inputs to the address signals. The inputs from the prompt unit 100 may be the combinations of the characters at the first indicator region and the second indicator region. The address signals could be a packet including the ID code and the address information. The communication unit 401 could be a weird or wireless communication module. The procession unit 403 transmits the address signal to the host 60 via the communication unit 407.

In one implementation, the comparison table is only stored in the host 60 and the host 60 recognizes the address information after receiving the address signal including the characters at the first indicator region and the second indicator region according to the comparison table.

| | Character at | |
|---|---|---|
| Character at | second setting | Address |
| first setting unit | unit | information |
| A | 00 | Living room |
| B | 01 | Kitchen |
| C | 10 | Bedroom |
| D | 11 | Dining room |
| 1 | 000 | Door |
| 2 | 001 | Window |
| 3 | 010 | Wall |

The communication unit 407 is configured to receive the control signal from the host 60 and the processing unit 403 controls the power switch unit 413 according to the received control signal. As such, the power input unit 409 may be in connection with or disconnected from the power output unit 415. Therefore, the host 60 could remotely control the receptacle 4 to deliver or not deliver the power to the electronic loads 21 and 23.

In one implementation, the receptacle device 4 may not include the power switch unit 413 with the receptacle device 4 providing the address information and detecting the environmental condition or the power status.

The detection unit 411 is configured to detect the current, the voltage or the power consumption of the power input unit 409 and detect the temperature, the concentration of carbon dioxide or the humidity. The processing unit 403 could generate a detection signal according to the detection result of the detection unit 411. The detection signal could be a packet containing the ID code and the power status information, or the ID code and the environmental condition information. The detection signal is transmitted to the host 60 by the communication unit 407. The detection signal and the address signal may be transmitted to the host 60 at the same time. When the detection signal and the address signal are transmitted to the host 60 at the same time, the host 60 may identify the environmental condition and/or the power status at the address where any particular receptacle device locates. When the detection signal and the address signal are not transmitted to the host 60 at the same time, the host may compare the ID code in each of the detection signal and the address signal before getting the information of the environmental condition and the power status of any particular receptacle device. Therefore, the user would be able to repair the receptacle device 4 when any unusual event occurs.

In one implementation, the memory unit 405 is configured to store a threshold of power consumption. The processing unit 403 compares the detection signal with the threshold before controlling the power switch unit 413 accordingly.

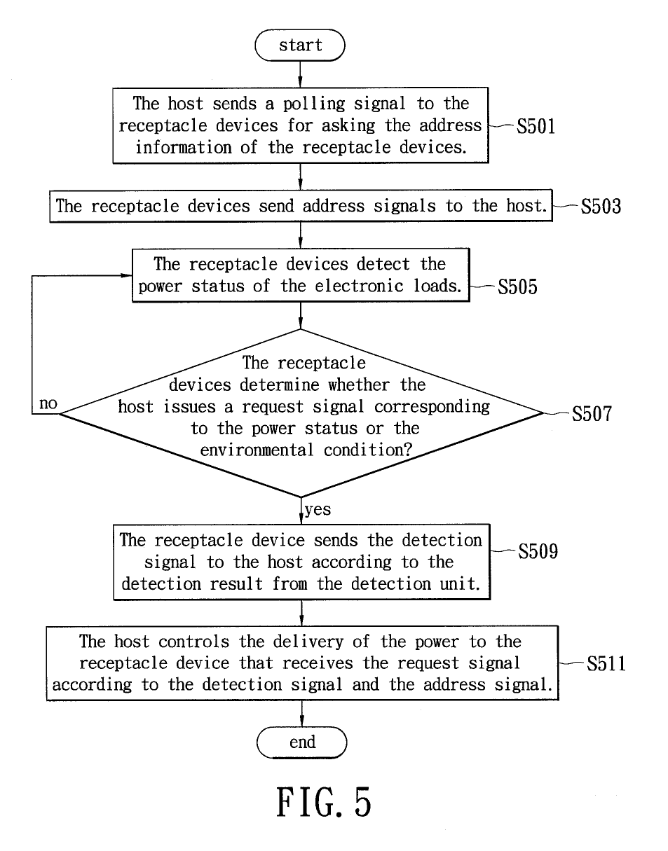

FIG. 5 is a flowchart illustrating a managing method of the power management system in accordance with one embodiment of the present invention.

After the receptacle devices 1 and 1′ are powered and the address information of the receptacle devices 1 and 1′ are set, the mutual communication between the receptacle device 1 and 1′ and the host 60 may be established. The host 60 sends a polling signal to the receptacle devices 1 and 1′ for asking the address information of the receptacle devices 1 and 1′, respectively (S501). The receptacle devices 1 and 1′ send address signals to the host 60 in a same sequence as that the receptacle devices receive the polling signal (S503). The receptacle devices 1 and 1′ may then detect the power status of the electronic loads 21 and 23 such as the current, the voltage or the power consumption, or detect the environmental condition around the receptacle devices 1 and 1′ (S505).

The receptacle devices 1 and 1′ determine whether the host 60 issues a request signal corresponding to the power status or the environmental condition (S507). If the receptacle devices 1 and 1′ do not receive the request signal, the receptacle devices 1 and 1′ may continue detecting the power status or the environmental condition regularly (S505). If any one of the receptacle devices 1 and 1′ receives the request signal, the receptacle device receiving the request signal sends the detection signal to the host 60 according to the detection result from the detection unit 406 (S509). The host 60 controls the delivery of the power to the receptacle device that receives the request signal according to the detection signal and the address signal (S511).

What are disclosed above are only the specification and the drawings of the preferred embodiment of the present invention and it is therefore not intended that the present invention be limited to the particular embodiment disclosed. It will be understood by those skilled in the art that various equivalent changes may be made depending on the specification and the drawings of the present invention without departing from the scope of the present invention.

What is claimed is:

1. A receptacle device for receiving an electronic load, comprising:
a body,
a setting unit disposed in the body for setting an address information of the receptacle device,
a processing unit disposed in the body for generating an address signal according to the address information, and
a communication unit disposed in the body for transmitting the address signal to a host.

2. The receptacle device as claimed in claim 1, further comprising a power switch unit disposed in the body and coupled with the processing unit.

3. The receptacle device as claimed in claim 2, wherein the communication unit receives a control signal from the host.

4. The receptacle device as claimed in claim 3, wherein the processing unit controls the power switch unit to deliver or not to deliver a power to the electronic load.

5. The receptacle device is claimed in claim 1, wherein the setting unit is a dip switch, a knob switch or a press portion for setting the address information relative to a position and a division of the receptacle device.

6. The receptacle device is claimed in claim 1, further comprising a detection unit coupled with the processing unit for detecting the power or environmental condition and generating a detection signal.

7. A power management system, comprising:
a plurality of receptacle devices for receiving an electronic load wherein each of the receptacle devices comprises:
a body;
a setting unit for setting an address information of the receptacle device;
a processing unit for generating an address signal according to the address information; and
a communication unit for transmitting the address signal; and
a host for receiving the address signal and transmitting a control signal to the receptacle devices;
wherein the processing unit controls the receptacle devices to deliver power to the electronic load.

8. The power management system as claimed in claim 7, wherein each one of the receptacle devices further comprises a detection unit.

9. The power management system as claimed in claim 8, wherein the processing unit generates a detection signal according to a detection result of the detection unit transmitted to the host via the communication unit.

10. A power managing method of a power management system, wherein the power management system comprising a plurality of receptacle devices and a host, the power managing method comprising:
transmitting a polling signal to the receptacle devices by the host;
transmitting an address signal to the host by the receptacle device wherein the address signal corresponds to an address information of the receptacle device; and
controlling the receptacle devices to deliver a power to an electronic load by the host.

11. The method as claimed in claim 10, wherein the address signal comprises an identification code and an address information.

12. The method as claimed in claim 11, further comprising transmitting a detection signal to the host by the receptacle device.

13. The method as claimed in claim 12. further comprising transmitting a control signal to the receptacle devices according to the detection signal by the host.

14. A receptacle device for receiving an electronic load, comprising:
a body,
a first setting unit disposed in the body for setting a division information of the receptacle device,
a second setting unit disposed in the body for setting a position information of the receptacle device,
a processing unit disposed in the body for generating at least one address signal according to the division information and the position information,
a communication unit disposed in the body for transmitting the address signal to a host, and
a plug interface disposed in the body for receiving at least one electrical plug.

15. The receptacle device is claimed in claim 14, wherein the body including a first indicator region and a second indicator region, the first indicator region disposed in the body for instructing the division information of the receptacle device, the second indicator region disposed in the body for instructing the position information of the receptacle device.

16. The receptacle device is claimed in claim 14, further comprising a power switch unit, the communication unit receives a control signal from the host, the processing unit controls the power switch unit according to the control signal.

17. The receptacle device is claimed in claim 14, further comprising a detection unit, a power switch unit and a memory unit, the detection unit detects power consumption, the memory unit stores a power threshold, the processing unit compares the power consumption with the power threshold before controlling the power switch unit accordingly.

18. The receptacle device is claimed in claim 14, further comprising a detection unit, the processing unit generates a detection signal according to a detection result of the detection unit, the detection signal including a power status information and a ID code of the receptacle device, the communication unit transmits the detection signal to the host.

19. The receptacle device is claimed in claim 14, further comprising a detection unit, the processing unit generates a detection signal according to a detection result of the detection unit, the detection signal including an environmental condition information and a ID code of the receptacle device, the communication unit transmits the detection signal to the host.
